(19) United States
(12) Patent Application Publication
(10) Pub. No.: US 2007/0035878 A1
(43) Pub. Date: Feb. 15, 2007

(54) Perpendicular head with self-aligned notching trailing shield process

(76) Inventors: Hung-Chin Guthrie, Saratoga, CA (US); Yimin Hsu, Sunnyvale, CA (US); Ming Jiang, San Jose, CA (US)

Correspondence Address: Maryam Imam, Esq.;LAW OFFICES OF IMAM, Suite 1010, 111 North Market Street, San Jose, CA, 95113, US

(21) Appl. No.: 11/201,466

(22) Filed: Aug. 10, 2005

(51) Int. Cl. G11B 5/127

(52) U.S. Cl. 360/125

(57) ABSTRACT

A perpendicular write head and a method of manufacturing the same is disclosed, the perpendicular write head for writing data onto tracks, the perpendicular write head having a main pole having notched trailing shield being self-aligned on the main pole for improved overwriting and adjacent track interference.

### BACKGROUND OF THE INVENTION

1. Field of the Invention

This invention relates generally to the field of perpendicular magnetic recording heads and more particularly, to a notched trailing shield thereof and a method for manufacturing the same to avoid magnetic field leakage thereby improving overwrite and adjacent track interference problems.

2. Description of the Prior Art

As the recording density of magnetic hard drives (or disk drives) increases, a physical limitation is experienced using longitudinal recording systems partly due to thermal relaxation known as super-paramagnetism. That is the density requirements for meeting today's storage needs are simply not attainable with longitudinal recording systems. To provide further insight into this problem, it is anticipated that longitudinal recording systems will lose popularity as storage capacities in excess of about 150 Gigabytes-per-square-inches become a requirement. These and other factors have lead to the development and expected launch of perpendicular recording heads or write heads. Perpendicular recording is promising in pushing the recording density beyond the limit of longitudinal recording.

Accordingly, perpendicular recording potentially can support much higher linear density than longitudinal recording due to lower demagnetizing fields in recorded bits, which diminish when linear density increases.

A magnetic recording head for perpendicular writing generally includes two portions, a writer for writing or programming magnetically-encoded information on a magnetic media or disk and a reader portion for reading or retrieving the stored information from the media.

The writer of the magnetic recording head for perpendicular recording typically includes a main pole and a return pole, magnetically separated from each other, at an air bearing surface (ABS) of the writer by a nonmagnetic gap layer, and which are magnetically connected to each other at a back gap closure (yoke). This structure is referred to as a single-pole write head because while a main pole and return pole are referred thereto, the return pole is not physically a pole, rather, it serves to close the loop with the main pole and the soft under layer for magnetic flux circuit.

Positioned at least partially between the main and return poles are one or more layers of conductive coils encapsulated by insulation layers. The ABS is the surface of the magnetic head immediately adjacent to the recording medium.

To write data to the magnetic medium, an electrical current is caused to flow through the conductive coil, thereby inducing a magnetic field through the write head yoke, fringing across the write head gap at the media. By reversing the polarity of the current through the coil, the polarity of the data written to the magnetic media is also reversed.

The main and return poles are generally made of a soft magnetic material. Both of them generate magnetic field in the media during recording when the write current is applied to the coil.

In perpendicular recording heads, writing and erasing of information is performed by a single-pole write head. The main pole is composed of high moment magnetic materials, the most common example being cobalt-iron (CoFe) alloys or laminate layers.

With the advent of perpendicular recording heads, density has been greatly increased, as discussed hereinabove, which has lead to a greater need for accurate recording of data onto the desired track. That is, writing to adjacent tracks is. highly undesirable because it causes corruption of data on adjacent tracks. Additionally, overwriting reduction due to magnetic field leakage is currently a problem associated with perpendicular heads that is highly undesirable. In this connection, magnetic field leakage disrupts concentration of the magnetic field in a particular area, which results in less overwriting and reduced performance. Therefore, it is desirable to improve the concentration of magnetic field in a particular area thereby improving overwriting.

Perpendicular write heads generally have a trailing shield, side shields, a top pole and a bottom return pole. The main pole is generally shaped in a manner causing a tip or an extension thereof that is narrower than the remaining portion thereof to form a top pole. The side shields act to shield the top pole so as to reduce adverse affects on adjacent tracks during the writing of magnetic transitions (data) at a location on a given track. One way to address the problems associated with overwriting and adjacent track interference is by notching the trailing shield, however, due to small critical dimension and alignment issues, it is difficult to form notched trailing shield. That is, in perpendicular write heads, controlling the critical gap thickness, i.e. the thickness between the top pole and the trailing shield, is problematic, furthermore, the alignment of the trailing shield with the main pole is problematic. Yet another problem is damage to top pole and top pole corner rounding caused from chemical mechanical planarization (CMP) process, such as described in further detail below.

In the recording head, the main pole and trailing shield are separated by the gap layer, and require improvement for controlling the deposition of the gap layer so as to have well-controlled critical gap thickness between the top pole and the trailing shield.

The main pole is generally beveled (or trapezoidal) in shape in an effort to reduce adjacent track writing. Controlling the pole width so as to better line up with the track to be written thereto needs improvement also, as does controlling the angle of the bevel of the bevel-shaped design of the top pole.

It is vital for the corners of the bevel of the main pole to be straight rather than rounded, which is often experienced during manufacturing of the main pole and trailing shield. Such corner rounding generally results in the magnetic field that is induced onto the disc to be curved rather than straight. This effect adversely impacts system performance by degrading accurate recording of data onto the disc, as well as, unnecessarily higher power consumption.

Thus, in light of the foregoing, there is a need for a perpendicular recording head having a main pole and notched trailing shield manufactured to pattern the notched trailing shield and to eliminate top pole corner rounding while having well-controlled critical gap thickness between the main pole and the trailing shield and wherein the notched trailing shield is self-aligned with the main pole.

### SUMMARY OF THE INVENTION

Briefly, one embodiment of the present invention includes a perpendicular write head and a method of manufacturing the same, the perpendicular write head for writing data onto tracks, the perpendicular write head having a main pole having notched trailing shield being self-aligned on the main pole for improved overwriting and adjacent track interference.

### IN THE DRAWINGS

FIG. 1 shows a top perspective view of a disc drive 100 is shown in accordance with an embodiment of the present invention.

FIG. 2 shows an ABS view of a portion of the write head 112 having a trailing shield 200, side shields 206, a top pole 202 and a bottom return pole 204, which embodies the present invention.

FIGS. 3-11 show the relevant steps of manufacturing the main pole 202 and the trailing shield 200 in accordance with an embodiment and method of the present invention.

### DETAILED DESCRIPTION OF THE PREFERRED EMBODIMENT

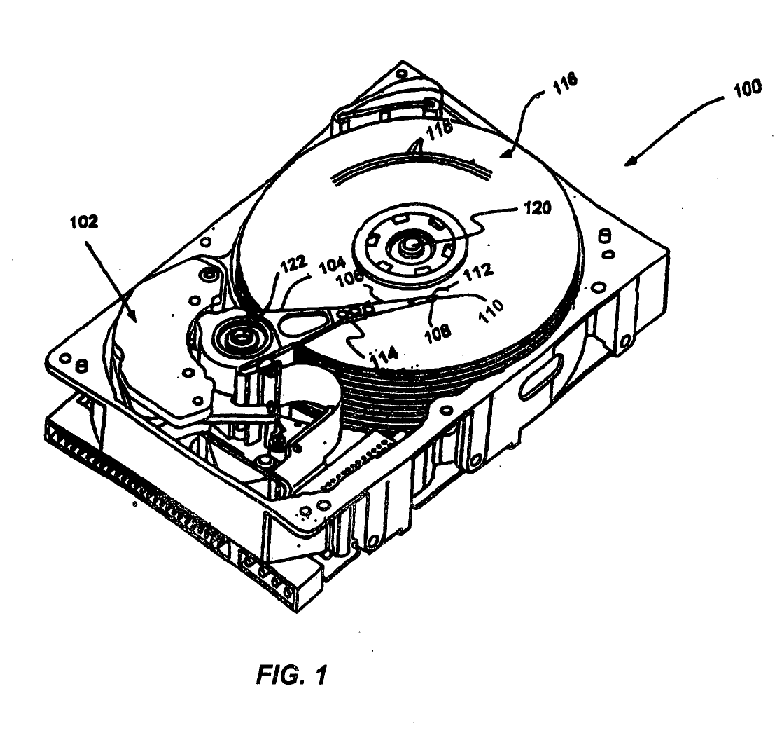

Referring now to FIG. 1, a top perspective view of a disk drive 100 is shown in accordance with an embodiment of the present invention. The disk 100 is shown to include a voice coil motor (VCM) 102, an actuator arm 104, a suspension 106, a flexure 108, a slider 110, a write (perpendicular) head 112, a head mounting block 114, and disk or media 116. Suspension 106 is connected to the actuator arm 104 at the head mounting block 114. The actuator arm 104 is coupled to the VCM 102. The disk (or disc) 116 includes a plurality of tracks 118 and rotates about axis 120. The tracks 118 are circular, each extending circularly around the surface of the disk 116 onto which magnetically-encoded data or information is stored (or programmed) using the perpendicular head 112, which will be discussed in greater detail with respect to further figures. The embodiments of the present invention reduce undesirable writing of adjacent tracks, as will be apparent shortly.

During operation of the disk drive 100, rotation of the disk 116 generates air movement which is encountered by the slider 110. This air movement acts to keep the slider 110 afloat a small distance above the surface of the disk 116, allowing the slider 110 to fly above the surface of the disk 116. The VCM 102 is selectively operated to move the actuator arm 104 around the axis 120, thereby moving the suspension 106 and positioning the—transducer (not shown), which includes a main pole (not shown), by the slider 110 over the tracks 118 of the disk 116. It is imperative to position the—transducer properly to read and write data from and to the concentric tracks 118.

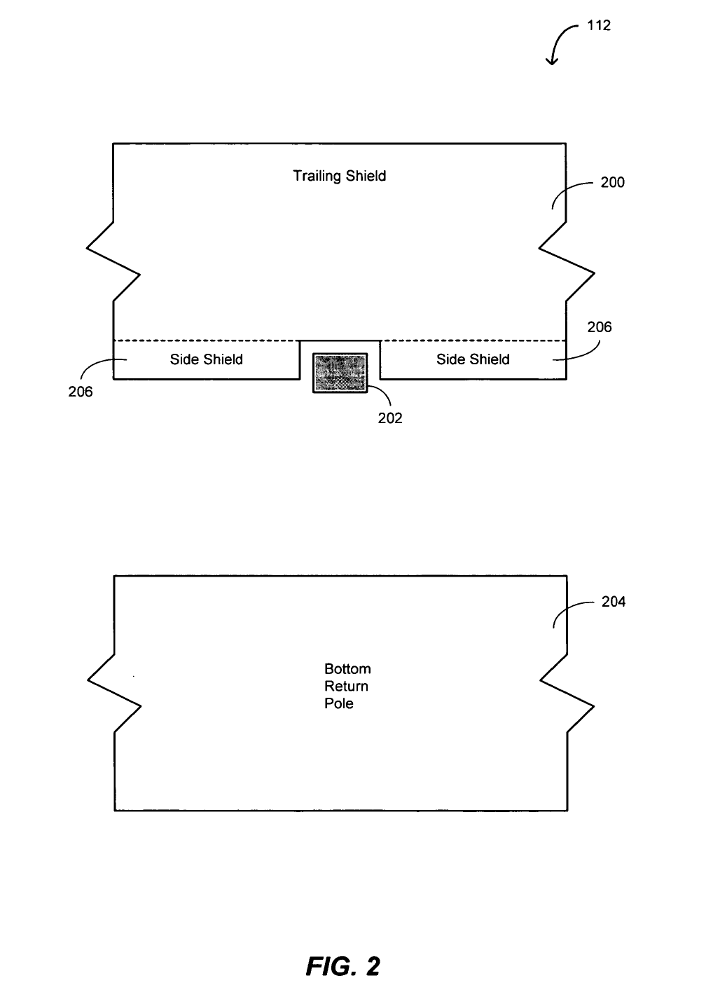

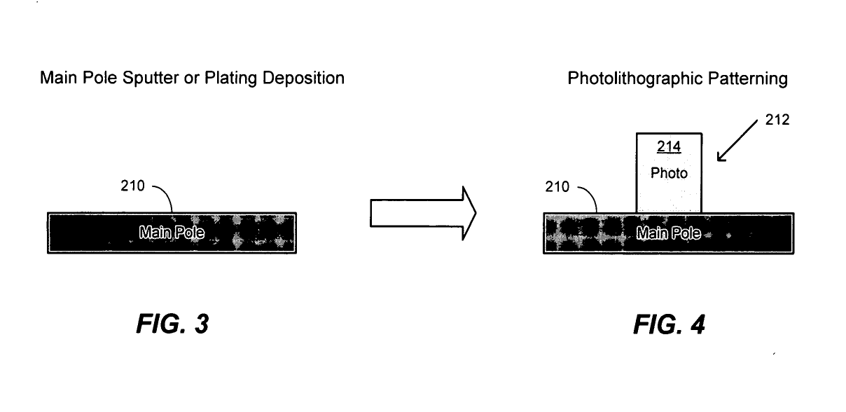

FIG. 2 shows an ABS view of a portion of the write head 112 having a—trailing shield 200, side shields 206, a main pole 202 and a bottom return pole 204, which embodies the present invention. As earlier noted, the main pole is generally shaped in a manner causing a tip or an extension thereof that is narrower than the remaining portion thereof to form a top pole. The side shields 206 act to shield the top pole so as to reduce adverse affects on adjacent tracks during the writing of magnetic transitions (data) at a location on a given track. It is the manufacturing and structure of the main pole 202, as will be described in further detail, that eliminates top pole damage and corner rounding resulting from CMP and that help to self-align the notched trailing shield 200 and that help to control the critical gap thickness between the main pole 202 and the notched trailing shield 200. FIGS. 3-11 show the relevant steps of manufacturing the top pole 202 and the—trailing shield 200, of FIG. 2, in accordance with an embodiment and method of the present invention. FIG. 3 shows a main pole material 210, known to those skilled in the art. Next, main pole sputtering or plating deposition process is performed followed by photolithographic patterning, as shown in FIG. 4, to create the structure 212 with a photolithographic layer 214 patterned on top of the main pole material 210. In one embodiment of the present invention, the layer 214 is made of diamond-like carbon (DLC) acting as a stop layer during a chemical mechanical planarization (CMP) process to follow.

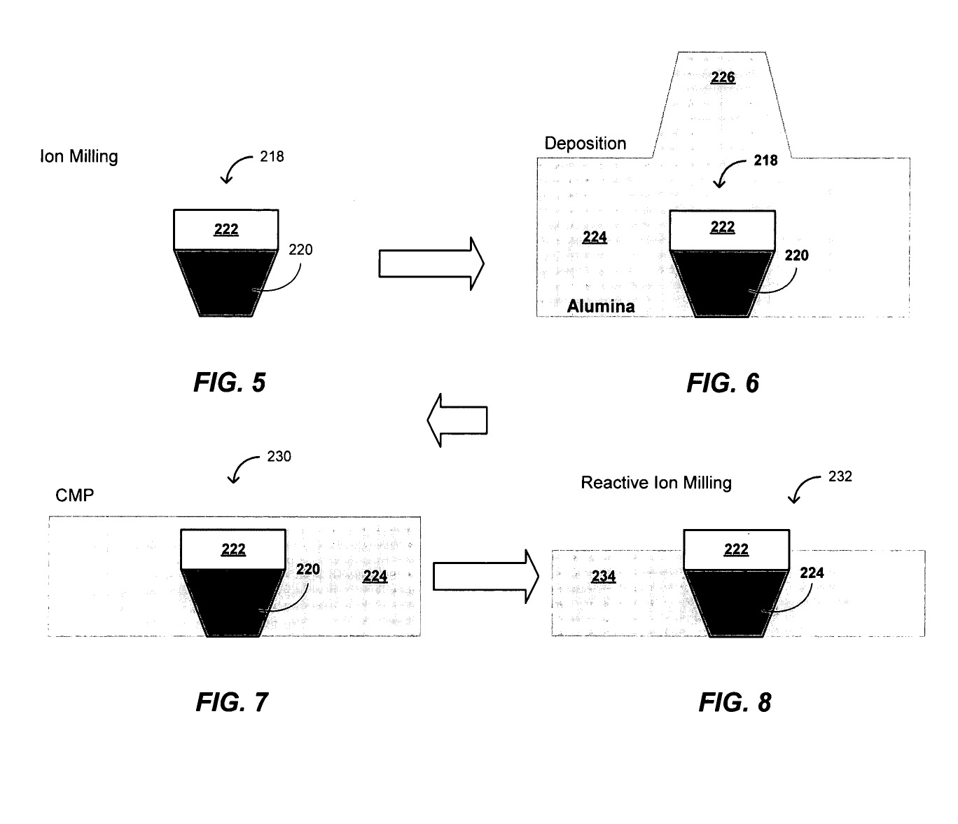

Next, an ion milling process is performed to create the structure 218 of FIG. 5, which shows the pole 210, of FIG. 4, beveled in shape creating the beveled main pole 220 on top of which is shown the layer 214 of FIG. 4 reduced in height to create the layer 222 of FIG. 5. The pole width and beveling of the pole 220 results from the ion milling process. Next, as shown in FIG. 6, alumina layer 224 is deposited all around and on top of the structure 218. Due to the presence of the structure 218, a dome-shaped alumina structure 226 appears as a part of the alumina layer deposition where the alumina layer is raised above the structure 218. Alumina is the same as A1₂O₃. The layer 224, refilling of the structure 218, of FIG. 6, serves as support thereof.

Next, in FIG. 7, a CMP process 230 is performed to remove the structure 226 and to planarize the alumina layer 224. CMP process 230 is essentially used to planarize the surface of the structure before depositing the trailing shield 200.

Next, a reactive ion milling process 232 is performed, as shown in FIG. 8, for removing a portion, or reducing the thickness, of the alumina layer 224 to obtain the flat alumina layer 234. The reactive ion milling process reduces the alumina layer to the alumina layer 234 being at least 100 nanometers above the top of the main pole (the layer 224). The layer 234 remains to become a part of the perpendicular recording head. The reactive ion milling process 232, in combination with the CMP process of FIG. 7 are referred to as a reactive ion milling assisted CMP and the process 232 subsequent to the CMP process helps to eliminate top (or main) pole corner rounding, which is highly desirable for reasons previously stated.

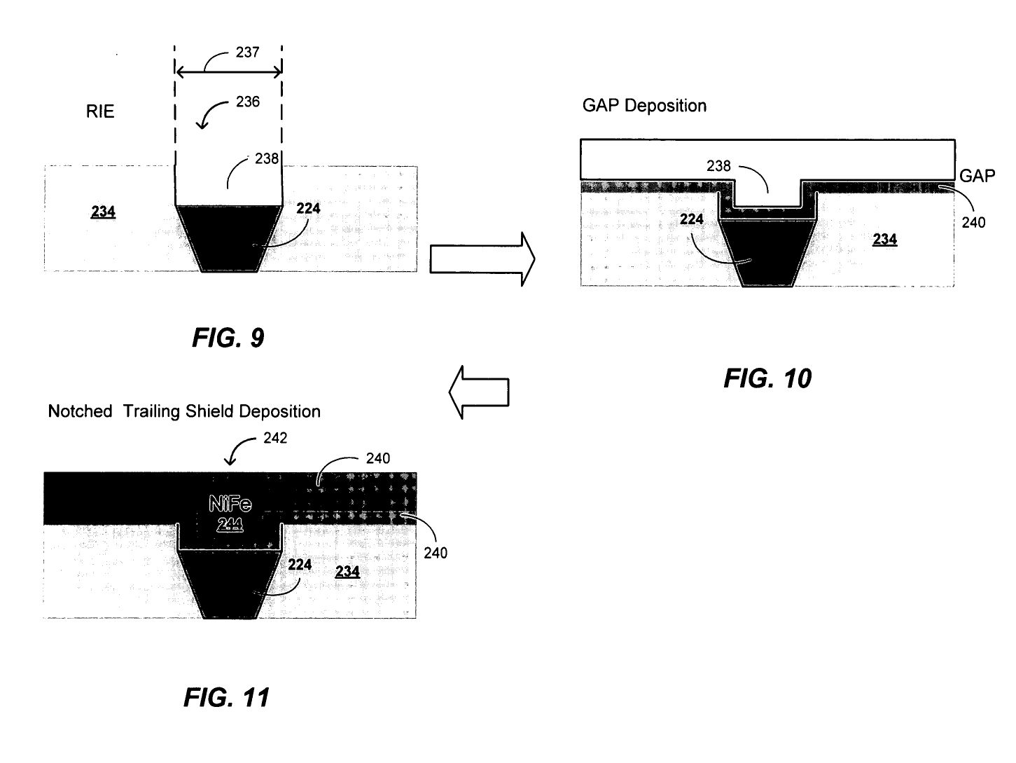

Next, in FIG. 9, a reactive ion etching process 236 is performed to remove the layer 222 forming a trench 238, which is essentially an empty space or void into which a gap layer 240 is deposited, as shown in FIG. 10. After the reactive ion etching process 236, the main pole or top pole (pole material 224) is essentially opened at 238. As described herein, the method of the present invention allows for the creation of a trench and the formation of the notch of a notched trailing shield, wherein the notch is self-aligned with the top of the main pole due to the process taught by the present invention. The self-alignment feature provides major advantages because the critical dimensions of the main pole and the trench are so small and will gradually be even smaller that the alignment of the notch with the top of the main pole has become a great technical challenge not easily surmountable by the prior art photolithography processes. The gap layer 240 is deposited into the trench 238 as well as on top of the layer 234. In one embodiment of the present invention, the gap layer 240 is—made of Rhodium, which is serving as both gap and seed layer for self-aligned notching trailing shield. In one embodiment of the present invention, the gap layer 240 is 50 nanometers in thickness, however, it can be anywhere from 10-100 nanometers in thickness.

The track width is basically defined at 237 of FIG. 9 and some of the preceding figures by the width of the top edge of the trapezoidal shaped main pole. It is important to prevent erosion from CMP thereof for proper writing of data onto tracks. The trench 238 eliminates corner rounding to prevent curved transition of the magnetic flux utilized for programming data onto tracks, as apposed to the desired sharp transitions. That is, the desired transitions should be perpendicular to the concentric tracks and in the presence of corner rounding, these transitions, rather than being sharp, i.e. perpendicular, are curved. In one embodiment of the present invention, the depth of the trench is within the range of 50-200 nanometers (nm) which defines the size of the notch of the trailing shield, described shortly and that is deposited into the trench.

The presence of the notch helps to align the main pole and the trailing shield. After deposition of the gap/seed layer 240, in FIG. 10, a notched trailing shield 240, having a notch at 244 to electroplate into the trench 238, is deposited on top of the gap layer 240 to form the structure 242, as shown in FIG. 11. In an alternative embodiment, the gap between the top of the main pole and the trailing shield may comprise at least two different layers, a seed layer deposited on top of a gap layer, the gap layer being magnetically non-conductive and the seed layer being electrically conductive. In one embodiment of the present invention, the notched trailing shield 240 is made of NiFe. The structure 242 shows the main (or top) pole separated from the notched trailing shield by a gap layer. The notched trailing shield 240 of the structure 242 improves overwriting and adjacent track interference problems associated with prior art perpendicular write heads. It should be noted that the figures presented and discussed herein are not drawn to scale. Furthermore, the trench 238 and the notch of the notched trailing shield are not necessarily perfectly angled, as shown.

Although the present invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claimed is:

1. A perpendicular write head for writing data onto tracks, each having widths defining a track width comprising:
a main pole;
a first layer on top of the main pole, the first layer being shaped like a trench;
a gap layer deposited into the trench; and
a trailing shield formed on top of the gap layer, the trailing shield having a notch aligned with the main pole.

2. A perpendicular write head, as recited in claim 1, including an alumina layer formed around the main pole and under the gap layer.

3. A perpendicular write head, as recited in claim 1, wherein the gap layer is made of Rhodium.

4. A perpendicular write head, as recited in claim 1, wherein the gap layer has a thickness within the range of 10-100 nanometers.

5. A perpendicular write head, as recited in claim 1, wherein the notched trailing shield is made of NiFe.

6. A method of manufacturing a perpendicular write head comprising:
photolithographic patterning a first layer on top of a main pole layer;
ion milling the patterned first layer;
depositing alumina layer around and on top of the milled patterned first layer;
planarizing the deposited alumina layer;
reactive ion milling the planarized alumina layer to a desired thickness;
reactive ion etching to remove the photolithographic patterning and to form a trench on top of the main pole;
depositing a gap layer into the trench and on top of the planarized alumina layer; and
depositing a trailing shield into the trench and on top of the gap layer to form a notched trailing shield self-aligned with the main pole.

7. A method of manufacturing a perpendicular write head, as recited in claim 6, wherein the planarization step is a chemical mechanical planarization (CMP) process.

8. A method of manufacturing a perpendicular write head, as recited in claim 6, wherein the notched trailing shield has a notch thickness defined by the thickness of the trench and further wherein the reactive ion milling step mills the alumina layer to the desired thickness for controlling notching depth.

9. A method of manufacturing a perpendicular write head, as recited in claim 6, wherein the deposition of alumina layer causes a raised alumina structure on top of the patterned main pole material, which is removed during the planarization step.

10. A method of manufacturing a perpendicular write head, as recited in claim 6, wherein the depth of the trench is within the range 50-200 nanometers.

11. A method of manufacturing a perpendicular write head, as recited in claim 6, wherein the gap layer is made of Rhodium.

12. A method of manufacturing a perpendicular write head, as recited in claim 11, wherein the thickness of the gap layer is within the range 10-100 nanometers.

13. A method of manufacturing a perpendicular write head, as recited in claim 6, further notched trailing shield is made of NiFe.

14. A method of manufacturing a disc drive having a perpendicular write head comprising:
photolithographic patterning on top of main pole material;
ion milling the patterned main pole material;
depositing alumina layer around and on top of the milled patterned main pole material;
planarizing the deposited alumina layer;
reactive ion milling the planarized alumina layer to a desired thickness;
reactive ion etching to remove the photolithographic patterning and to form a trench;
depositing a gap layer into the trench and on top of the planarized alumina layer; and
depositing trailing shield into the trench and on top of the gap layer to form a self-aligned notched trailing shield.

15. A method of manufacturing a perpendicular write head, as recited in claim 14, wherein the planarization step is a chemical mechanical planarization (CMP) process.

16. A method of manufacturing a perpendicular write head, as recited in claim 14, wherein the notched trailing shield has a notch thickness defined by the thickness of the trench and further wherein the reactive ion milling step mills the alumina layer to the desired thickness for controlling notching depth.

17. A method of manufacturing a perpendicular write head, as recited in claim 14, wherein the deposition of alumina layer causes a raised alumina structure on top of the patterned main pole material, which is removed during the planarization step.

18. A method of manufacturing a perpendicular write head, as recited in claim 14, wherein the depth of the trench is within the range 50-200 nanometers.

19. A method of manufacturing a perpendicular write head, as recited in claim 14, wherein the gap layer is made of Rhodium.

20. A method of manufacturing a perpendicular write head, as recited in claim 19, wherein the thickness of the gap layer is within the range 10-100 nanometers.

21. A method of manufacturing a perpendicular write head, as recited in claim 14, further notched trailing shield is made of NiFe.

22. A disc drive comprising:
a perpendicular write head for writing data onto tracks, each having widths defining a track width having,
a main pole having a trench;
a gap layer deposited into the trench; and
a notched trailing shield formed on top of the gap layer, the notched trailing shield and the main pole being aligned for improved track width control.

23. A perpendicular write head, as recited in claim 22, including an alumina layer formed around the top pole and under the gap layer.

24. A perpendicular write head, as recited in claim 22, wherein the gap layer is made of Rhodium.

25. A perpendicular write head, as recited in claim 22, wherein the gap layer has a thickness within the range of 10-100 nanometers.

26. A perpendicular write head, as recited in claim 22, wherein the notched trailing shield is made of NiFe.

27. A perpendicular write head, as recited in claim 22, wherein the trailing shield is notched in shape.
